(19) United States
(12) Patent Application Publication
(10) Pub. No.: US 2010/0067563 A1
(43) Pub. Date: Mar. 18, 2010

(54) METHOD AND SYSTEM OF COMMUNICATIONS

(75) Inventors: Hai Wang, Beijing (CN); Qingyu Miao, Beijing (CN)

Correspondence Address: HARRITY & HARRITY, LLP, 11350 RANDOM HILLS RD., SUITE 600, FAIRFAX, VA, 22030, US

(73) Assignee: TELEFONAKTIEBOLAGET LM ERICSSON (PUBL), Stockholm (SE)

(21) Appl. No.: 12/438,673

(22) PCT Filed: Aug. 25, 2006
(86) PCT No.: PCT/CN06/02197

§ 371 Date: Oct. 21, 2009

(51) Int. Cl. H04B 1/707; H04B 17/00

(52) U.S. Cl. 375/144; 455/67.11; 375/E01.032

(57) ABSTRACT

A communications estimation, in radio communications systems, particularly in CDMA type of systems, of signal to interference ratio, signal to noise ratio and signal to interference and noise ratio, includes one or more channel specific parameters in addition to one or more parameters related to received signal, noise or interference.

### TECHNICAL FIELD

The present invention relates to radio communications systems, and more especially it relates to communications estimation of signal to interference ratio, signal to noise ratio and signal to interference and noise ratio. Particularly, it relates to such estimation in CDMA type of systems.

### BACKGROUND

Estimation of signal to interference ratio, SIR, signal to noise ratio, SNR, signal to interference and noise ratio, SINR, and similar measures estimating one or more relations between desired signal and undesired one or more signals and noise is vital in many modern communications systems. In the sequel such estimation is referred to as SINR estimation for short. CDMA2000 and WCDMA are non-exclusive examples of modern communications systems where such estimation is applicable.

FIG. 1 schematically illustrates a radio base station <<RBS>>, in UMTS functionally referred to as Node B, and user equipment <<UE>>. The radio base station <<RBS>> emits radio signals destined for the user equipment <<UE>> in downlink direction <<DL>> and the mobile station emits radio signals destined for the radio base station <<RBS>> in uplink direction <<UL>>. Each of the user equipment <<UE>> and radio base station <<RBS>> may use one or more antennas common for transmissions in both uplink and downlink directions, or different antennas for uplink and downlink directions.

Prior art transmission power control may be arranged in an inner loop and an outer loop. The inner loop requires fast estimation to compensate for rapid changes typically due to fading of desired signal or new unwanted signals reaching the receiver. Indirect user-quality measures such as SINR, for estimation of varying channel characteristics are well suited for such inner loop estimation. In outer loop estimation, requirements on speed may be relaxed and estimates on direct user quality parameters may be used, e.g. bit error rate, BER, or frame error rate, FER.

With post-RAKE combining, true pilot symbol SINR is

$${SINR}_{sym} = {SF}_{pilot} \cdot {p}_{pilot} \cdot \frac{‖ {\hat{h}}^{H} h ‖}{{\hat{h}}^{H} {R}_{u} \hat{h}} , \qquad ( 1 )$$

where Rᵤ is noise covariance

Rᵤ=Rᵥ−pₜₒₜ·hh^{H}, (2)

Rᵥ is covariance of total received signal and noise, and h is channel coefficient vector, ĥ is estimated channel coefficient vector, pent is the power of the total transmitted signal, pₚᵢₗₒₜ is the power of the transmitted pilot signal, and SFₚᵢₗₒₜ is spreading factor of the pilot signal.

Louay M. A. Jalloul, ‘Multichannel Baseband Processor for Wideband CDMA’, EURASIT Journal on Applied Signal Processing, November 2005, describes a single-Chip multichannel transceiver capable of processing and demodulating signals from multiple users simultaneously. It is optimized to process different classes of code-division multiple-access signals. Section 3.3 describes a multipath searcher, and section 3.4 RAKE receiver architecture. In section 4.1, the carrier to interference ratio, C/I, required for demodulation is discussed and in section 4.2, the cell capacity is expressed in terms of information bit energy-to-interference-plus-noise ratio.

F. C. M. Lau and W. M. Tam, ‘Novel SIR-Estimation-Based Power Control in a CDMA Mobile Radio System Under Multipath Environment,’ IEEE Transactions on Vehicular Technology, vol. 50, No. 1, January 2001, describes a decisive algorithm based on signal-to-interference power ratio estimation to control transmission power of mobile stations in a code-division multiple-access mobile radio system under multipath environment. Five decision rules are proposed to determine the power control commands for the mobiles, and are compared to closed loop power control sending transmission power control commands depending on whether average SIR is greater or less than a preset threshold.

S. Gunaratne, T. G. Jeans, R. Tafazolli and B. G. Evans, Comparison of SIR Estimation Techniques for Closed-Loop Power Control in the W-CDMA System,’ European Wireless 2002 EW2002, February, 2002, Florence, Italy, compares SIR (Signal to Interference-plus-noise Ratio) estimation techniques that can be used to optimize the closed-loop power control, CLPC, scheme in the W-CDMA system. The paper mentions that researchers apply such estimation techniques before or after RAKE combining of the signal. The authors focus on application of the estimation techniques to the CLPC scheme in the UMTS-FDD uplink and compare their performance. One SIR estimation algorithm, where processing is done before RAKE combining, is compared to another SIR estimation algorithm, where processing is done after RAKE combining. Pros and cons of the algorithms are discussed and a problem of overestimation related to processing before RAKE combining is highlighted.

Kimmo Kettunen, ‘Enhanced Maximal Ratio Combining for Rake Receivers in Mobile CDMA Terminals,’ 5th Nordic Signal Processing Symposium NORSIG-2002, Oct. 4-7, 2002 Hurtigruten, Norway, proposes a maximal ratio combining scheme for rake receivers in mobile CDMA terminals not requiring estimation of rake finger noise powers. The rake receiver structure of the system model correlates received signals at delays τ₁, τ₂, . . . τ_{L} with a signature sequence of the user and a scrambling sequence for the cell under consideration. The various multipath components 1, 2, . . . L are then combined. A conventional and a suggested combining scheme are analyzed.

Kim-Chyan Gan, Maximum Ratio Combining for a WCDMA Rake Receiver, Application Note AN2251, Rev. 2, November 2004, Denver, Colo., USA, describes and discusses briefly chip and symbol rate combining. With chip rate combining, the received time-delayed signal of each rake finger is descrambled/despread before maximum ratio combining, MRC. With symbol rate combining, the received time delayed signal is MRC combined before descrambling/despreading. In the Application Note, symbol-rate combining rather than chip-rate combining is used because symbol-rate combining requires fewer computations, especially when the spreading factor goes up. It points out that for most cases symbol-rate combining requires less memory than chip-rate combining. It also asserts that channel estimation is hard to achieve in chip-level combining. Symbol-level channel estimation is interpolated to chip-level for chip-level channel estimation.

FIG. 2 illustrates schematically symbol-level combining. FIG. 3 illustrates a basic block diagram for chip-level combining. In both figures, a path searcher <<Path Search>> searches for a time-window of strongest signal path components. A number, L, of delay elements <<τ₁>>, <<τ₂>> . . . <<τ_{L}>> distinguishes <<Dₛ>>, <<Dₕ>> L different signal paths of different propagation path delay over the communications channel and should span the channel delay spread for best performance. The appropriately delayed signal paths are despread <<DSₛ>>, <<DS_{c}>> with a spreading sequence <<s(t,τₛ)>> with appropriate phase <<τₛ>>. In FIG. 2, each delayed signal path is despread <<DSₛ, whereas in FIG. 3, a combined signal is despread <<DS_{c}>>. The combining <<MRCₛ>>, <<MRC_{c}>> is optimal ratio combining, where the various paths are weighted in relation to their signal strength, corresponding to the respective complex conjugated channel gain of the paths, <<h*(t,τₕ)>> as estimated <<Channel Estimation>>.

Gunaratne et al. conclude that post-RAKE estimation processing outperforms pre-RAKE processing for target values of E_{b}/N₀ considered. The conclusion is explained by the pre-RAKE SIR estimation scheme causing unnecessary ‘power down’ commands being generated at the base station, BS, causing the User Equipment, UE, to lower its power even when the actual received E_{b}/N₀ is low, thereby causing higher bit error rate, BER. Greater estimation errors are expected with pre-RAKE estimation due to the individual paths having smaller E_{b}/N₀ ratio than the combined signal of post-RAKE processing.

International Patent Application WO0060763 estimates signal to interference ratio by forming a weighted sum of individual interference estimates along each of a plurality of multi-paths, where the weighting is determined in accordance with estimated signal power along the various multi-paths. The estimate of signal to interference ratio is then formed as the ratio of the combined power estimate and the weighted sum of individual interference estimates.

3^{rd} Generation Partnership Project (3GPP): Technical Specification Group, Technical Specification Group Radio Access Network, Physical layer procedures (FDD), 3GPP TS 25.214 V6.4.0, France, December 2004, establishes the characteristics of the physicals layer procedures in the FDD mode of UTRA. Section 5.1.2.5 describes setting of uplink DPCCH/DPDCH power difference. The section also describes respective gain factors βₒ and β_{d} of the DPCCH (‘Dedicated Physical Control Channel’) and DPDCH (‘Dedicated Physical Data Channel’) codes of various transport format combinations, TFCs. Each TFC is indicated by a Transport Format Combination Indicator, TFCI, to the receiving side. Thereby, the TFC can be identified and received data be decoded and demultiplexed.

None of the cited documents above discloses a method and system of SINR estimation utilizing one or more channel parameters, such as channel orthogonality factor or channel coefficients, in addition to parameters related to received signal, noise or interference level.

### SUMMARY

Prior-art solutions generally provide accurate pilot symbol SINR after RAKE combining, when the channel impairments are dominated by additive white gaussian noise, AWGN. However, in other channel environments, such estimates tend to be less accurate. Further, in the case of high user data rates, the interference from the user itself is the dominating disturbing component. Existing prior-art SINR estimation does not perform well nor in such cases.

It is, consequently, an object of preferred embodiments of the invention to provide a method and system of SINR estimation operable in cases of high user data rates.

Another object of embodiments of the invention is to provide a method and system where the required time for SINR estimation is sufficiently short.

A related object of embodiments of the invention is to provide a method and system suitable for inner-loop power control in a system with inner and outer transmission power control.

A further object of preferred embodiments of the invention is to provide a method and system suitable for operations in a receiver utilizing rake combining of various signal paths.

It is also an object of embodiments of the invention to provide a method and system suitable for operations in CDMA based systems.

Finally, an object of embodiments of the invention is to provide a method and system adapted to a WCDMA system.

These objects are met by a method and system of SINR estimation including one or more channel parameters. The one or more channel parameters are estimated in the SINR estimator of a receiver entity or transferred to the receiver entity from a sender entity.

Preferred embodiments of the invention, by way of examples, are described with reference to the accompanying drawings below.

### BRIEF DESCRIPTION OF THE DRAWINGS

FIG. 1 schematically illustrates a radio base station and user equipment communicating in uplink and downlink directions in a radio communications system according to prior art.

FIG. 2 illustrates schematically symbol-level combining, according to prior art.

FIG. 3 illustrates a basic block diagram for chip-level combining, according to prior art.

FIG. 4 demonstrates an example estimation of received noise power pₙ according to the invention.

FIG. 5 schematically illustrates a basic block structure of a first non-limiting example embodiment of the invention.

FIG. 6 illustrates a SINR estimator according to a second non-limiting example embodiment of the invention.

FIG. 7 illustrates principal blocks of a non-limiting example realization of the invention

FIG. 8 illustrates schematically two apparatus of a simplified radio communications system operating according to the invention.

### DETAILED DESCRIPTION

In the following description, for purpose of explanation, specific details are set forth such as particular architectures, interfaces, techniques, etc. in order to provide a thorough understanding of the present invention. However, it will be apparent to those skilled in the art that the present invention may be practiced in other embodiments that depart from these specific details.

In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both Currently known equivalents as well as equivalents developed in the future, i.e., any elements developed that perform the same function, regardless of structure.

The invention discloses SINK estimation utilizing channel affected parameters, such as channel orthogonality factor or channel coefficients.

In a first non-limiting example embodiment of the invention, an orthogonality factor of the channel, for which SINK is estimated, is determined in addition to channel noise and received power.

In a second non-limiting example embodiment of the invention, weighted channel gain factors and received signal autocorrelation function form a basis for the SINK estimation, the weighted channel gain factors determining the power relation including desired signal power and undesired or total signal power.

A non-limiting example use of the invention is soft value scaling. Another non-limiting example use is SINK estimation for TPC command generation.

For a transmission channel, an orthogonality factor, α, is defined as

$$α = \frac{V \{ {‖ H ( m ) ‖}^{2} \}}{{( E \{ {‖ H ( m ) ‖}^{2} \} )}^{2}} \qquad ( 3 )$$

where H(m) is channel transfer function

H(m)=DFT(h(n),2Lₙ−1), (4)

where Lₕ is number of channel taps corresponding to channel delay spread, and V{•} is variance and E{•} is expected value.

The SINR can then be expressed as

$$\begin{matrix}{SINR}_{sym} = {SF}_{pilot} \cdot {p}_{pilot} \cdot \frac{{g}_{h}}{α \cdot {p}_{tot} \cdot {g}_{h} + {p}_{n}} , & ( 5 ) \\ = {SF}_{pilot} \cdot \frac{{p}_{pilot} \cdot {g}_{h}}{α \cdot RTWP + ( 1 - α ) \cdot {p}_{n}} , & ( 6 )\end{matrix}$$

where gₕ is channel energy gain

$${g}_{h} = {\sum }_{n} {‖ h ( n ) ‖}^{2} , \qquad ( 7 )$$

for a channel with impulse response h(n), RTWP is Received Total Wideband Power

RTWP=pₜₒₜ·gₕ+pₙ (8)

and pₙ is received noise power. The channel estimate, ĥ(n), includes, as well as SINR_{sym}, the pilot transmission power information, pₚᵢₗₒₜ,

ĥ(n)=\sqrt{pₚᵢₗₒₜ}h(n)+e(n) (9)

Estimating the orthogonality factor by

$$\hat{α} = \frac{V \{ {‖ \hat{H} ( m ) ‖}^{2} \}}{{( E \{ {‖ \hat{H} ( m ) ‖}^{2} \} )}^{2}} , \qquad ( 10 )$$

where Ĥ(m) is the discrete Fourier transform of ĥ(n),

Ĥ(m)=DFT(ĥ(n),2Lₕ−1), (11)

an example SINR estimate according to the first embodiment is,

$$SI \hat{N} {R}_{sym} = {SF}_{pilot} \cdot \frac{{\sum }_{n} {‖ \hat{h} ( n ) ‖}^{2}}{\hat{α} \cdot R \hat{TW} P + ( 1 - \hat{α} ) \cdot {\hat{p}}_{n}} , \qquad ( 12 )$$

where \hat{p}ₙ is bounded by the interval

0≦\hat{p}ₙ≦R\hat{T}WP. (13)

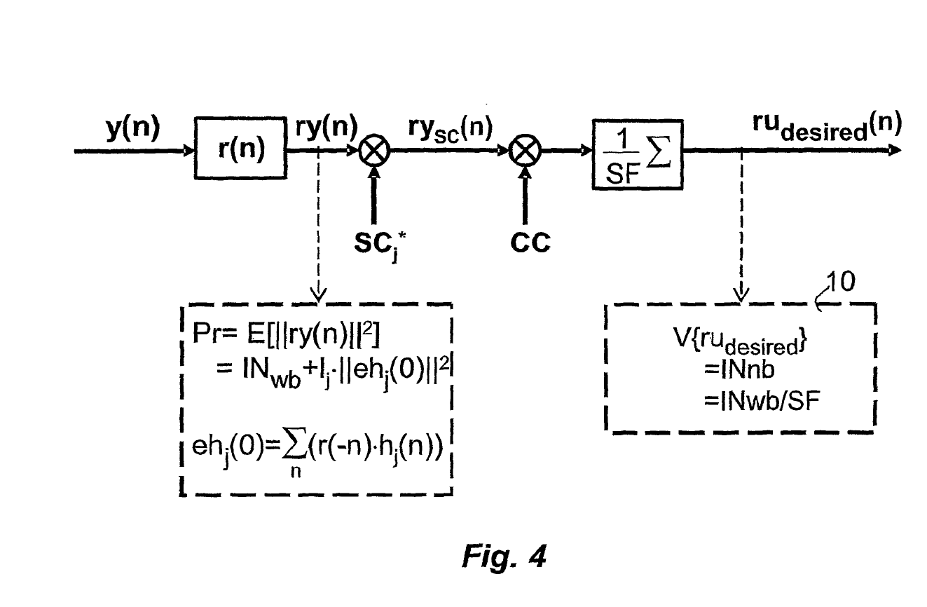

A preferred example estimate, \hat{p}ₙ, of received noise power pₙ, is achieved as illustrated in FIG. 4. A desired user signal <<ru_{desired}>> is determined from a received signal <<y(n)>>. The received signal is passed through a signal matched filter <<r(n)>>, the filter being matched to the transmitted signal. The filtered signal <<ry(n)>> output from the signal matched filter <<r(n)>> is despread by correlating with the complex conjugate of the spreading code SC <<SC*>>. The despread signal ry_{sc}(n) is then correlated with the channelization code <<CC>> for the channel of interest and integrated

$$≪ \frac{1}{SF} \sum ≫ .$$

For each base station j, transmitting at power level Pⱼ, the received level is after channel transport of data to a receiving unit. This power, Iⱼ, will be perceived as interference or noise in the receiving unit unless it stems from the serving base station. The power <<Pr>> of the received filtered signal <<ry(n)>> is composed of wide-band interference and noise <<IN_{wb}>> and transmitted signal power from the serving base station <<Iⱼ>>, scaled by the power amplification of the channel impulse response and the matched filter <<∥eh(0)∥²>>. When narrow-band interference and noise <<IN_{nb}>> is estimated from the despread signal, this is achieved by determining the variance <<V{ru_{desired}}>> of the received user signal <<ru_{desired}>>. The variance of the despread user signal corresponds to the interference and noise of the received filtered signal scaled by processing gain due to spreading <<IN_{wb}/SF>>.

The impact of the channel impulse response hⱼ(n) from base station j after filtering by the signal matched filter r(n) is eh(0), where

eh(n)=(r*hⱼ)(n), (14)

(r*hⱼ)(n) denoting convolution of r(n) and hⱼ(n). The signal matched filter is preferably matched such that eh(0)=1. The variance of the resulting signal <<ru_{desired}>> corresponds to the power of the effective interference plus noise <<IN_{nb}>> for the despread narrowband signal. It corresponds to the interference plus noise <<IN_{wb}>> of the wideband signal divided by the spreading factor <<SF>>.

A coarse estimate, \hat{p}ₙ, of the noise power is

$${\hat{p}}_{n} = \{ \begin{matrix}0 , & when self \text{-} interference is dominating \\ R \hat{TW} P , & when AWGN is dominating\end{matrix} . \qquad ( 15 )$$

FIG. 5 schematically illustrates a basic block structure of the first non-limiting example embodiment <<a6>>, of the invention. The blocks <<a1>>-<<a5>> directly correspond to functional parallel or serial steps as described above.

In FIG. 5, an input signal is processed to achieve an estimate, \hat{α}, of the orthogonality factor <<a2>>, by first determining the channel impulse response in accordance with equation (10) <<a1>>. The channel impulse response in equation (11) is preferably determined from information on the channel coefficients of a RAKE receiver (not illustrated in FIG. 5). Also received total wideband power <<a3>> and an estimate of received noise power <<a4>> are determined from the input. The noise power is preferably estimated in accordance with the method and apparatus described above in relation to FIG. 4. Also a coarse estimate, e.g. according to equation (13) or (15) is useful. The parameters determined <<a2>>, <<a3, <<a4>> are input to an estimator <<a5>> determining SI\hat{N}R_{sym}. For the purpose of understanding, the first non-limiting example embodiment has been illustrated with individual blocks <<a1>>-<<a5>>. However, it should be observed that the invention also covers integrating illustrated blocks or parts of blocks into merged blocks, parts of blocks being configured in relation to other illustrated blocks, or even the blocks <<a1>>-<<a5>> being integrated into a single entity <<a6>>. The invention covers realizations of the blocks entirely in hardware or in hardware with adapted software.

According to the second non-limiting example embodiment, no particular estimate of received noise power is required.

The ratio of UE pilot transmission power, pₚᵢₗₒₜ and total transmission power, pₜₒₜ, is known to the radio access network. In an example WCDMA system, the ratio is

$$\frac{{p}_{pilot}}{{p}_{tot}} = \frac{{‖ {β}_{c} ‖}^{2}}{{‖ {β}_{c} ‖}^{2} + {‖ {β}_{d} ‖}^{2}} , \qquad ( 16 )$$

where β_{c} and β_{d} are weighted gain factors for DPCCH (‘Dedicated Physical Control Channel’) and DPDCH (‘Dedicated Physical Data Channel’), respectively.

The gain factors β_{c} and β_{d} are signaled by layers higher than the physical layer as specified in 3GPP Technical Specification TS 25.214 V6.4.0. In uplink direction, the base station, or Node B using UMTS terminology, should decode TFCI to know which transport format is used.

There are corresponding gain factors for High Speed Packet Access, HSPA, users. In uplink direction, HS-DPCCH (‘High Speed Dedicated Physical Control Channel’), E-DPCCH (‘E-DCH Dedicated Physical Control Channel’), and E-DPDCH (‘E-DCH Dedicated Physical Data Channel’) are considered. The ratio of UE pilot transmission power, pₚᵢₗₒₜ, and total transmission power, pₜₒₜ, for an HSPA, user in an example WCDMA system, the ratio is

$$\frac{{p}_{tot}}{{p}_{pilot}} = \frac{{‖ {β}_{c} ‖}^{2} + {‖ {β}_{d} ‖}^{2} + {‖ {β}_{hs} ‖}^{2} + {‖ {β}_{ec} ‖}^{2} + {n}_{E \text{-} DPDCH} {‖ {β}_{ed} ‖}^{2}}{{‖ {β}_{c} ‖}^{2}} , \qquad ( 17 )$$

where β_{c} and β_{d} are gain factors as specified above, βₕₛ is gain factor for HS-DPCCH, which is derived from power offsets Δ_{ACK}, Δ_{NACK} and Δ_{CQI}, the power offsets being applied to HSPA users as compared to non-HSPA users. β_{ec} and β_{ed} are gain factors for E-DPCCH and E-DPDCH. These values are similar to β_{c} and β_{d} signaled by layers higher than the physical layer as specified in 3GPP Technical Specification TS 25.214 V6.4.0.

A symbol SINK estimate according to the second non-limiting example embodiment is

$$\begin{matrix}SI \hat{N} {R}_{sym} = {SF}_{pilot} \cdot \frac{{‖ {\hat{h}}^{H} \hat{h} ‖}^{2}}{{\hat{h}}^{H} {\hat{R}}_{u} \hat{h}} , \\ where & ( 18 ) \\ {\hat{R}}_{u} = {\hat{R}}_{v} - \frac{{p}_{tot}}{{p}_{pilot}} \cdot \hat{h} {\hat{h}}^{H} . & ( 19 )\end{matrix}$$

The estimated channel impulse response ĥ is preferably achieved from a Rake receiver, H denotes Hermitian transform,

$$\frac{{p}_{tot}}{{p}_{pilot}}$$

is determined in accordance with equation (17) and \hat{R}ᵥ is determined, preferably in a processing entity, from the auto-correlation function of the received wide-band signal before despreading and combining. The components of autocorrelation matrix \hat{R}ᵥ are

\hat{R}ᵥ(i,j)=E{v(n)v*(n−i+j)}, n, i, jε[0, 1, 2, . . . ] (20)

where v*(n) denotes the complex conjugate of the total received signal, v(n), including noise and interference.

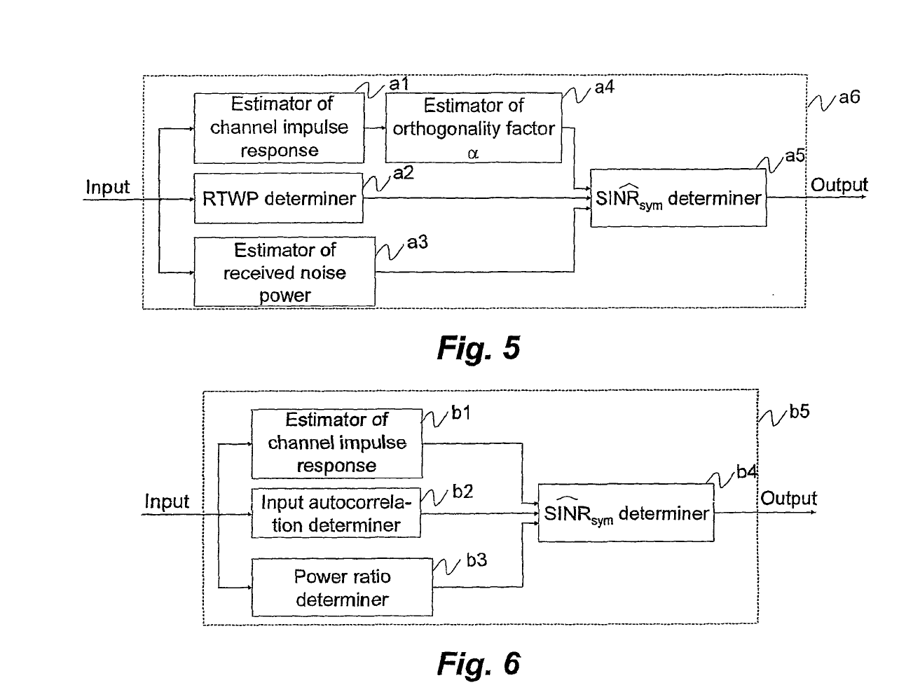

FIG. 6 illustrates a SINR estimator <<b5>> according to the second non-limiting example embodiment. As with the first non-limiting example embodiment, an estimate of the channel impulse response is determined <<b1>>. Preferably, the estimate is achieved from channel coefficients of a Rake receiver. The input autocorrelation is estimated <<b2>> and the power ratio of total received wideband power and pilot power before despreading and combining, cf. equation (16) for non-HSPA users and equation (17) for HSPA user. An estimate of the power ratio is determined from channel gains preferably communicated on a control channel and forming part of the input to the SINR estimator. The SINR estimate is finally determined <<b4>> from the estimates of the preceding blocks <<b1>>, <<b2>>, <<b3>>. The estimator <<b5>> preferably comprises one or more processing entities.

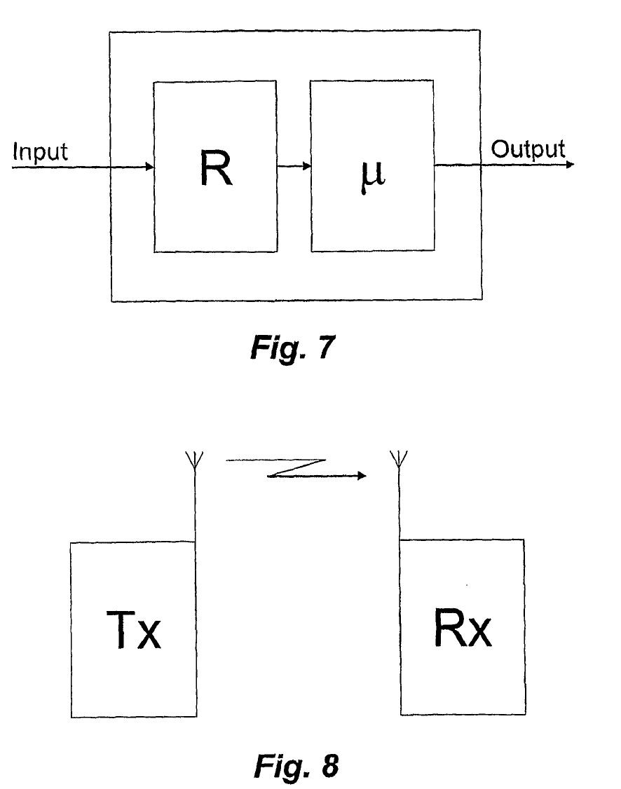

FIG. 7 illustrates principal blocks of a non-limiting example realization of the invention wherein an apparatus <<App>> of SINR estimation in a radio communications system comprises at least one receiving means <<R>> and at least one processing means <<μ>>. Receiving means <<R>> receives one or more channel specific parameters. The one or more parameters are transferred to processing means <<μ>> adapted for inclusion of the one or more channel specific parameters, such as channel orthogonality or channel gain factors as described above. According to a first non-limiting example embodiment, the channel gain is estimated in the receiver.

According to a second non-limiting example embodiment, the one or more channel gain factors are provided by a transmitter (not illustrated) and transferred from the receiving means <<R>> to the processing means <<μ>>.

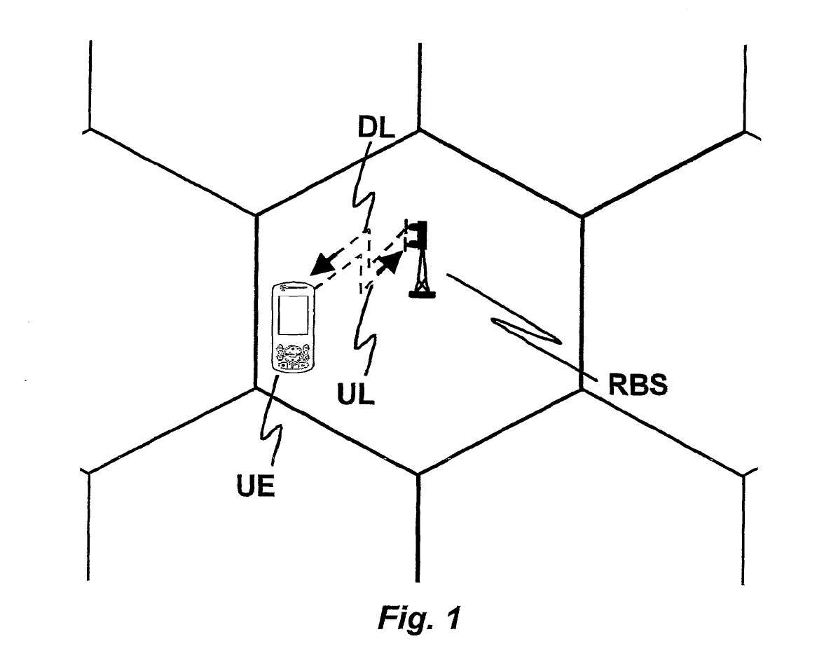

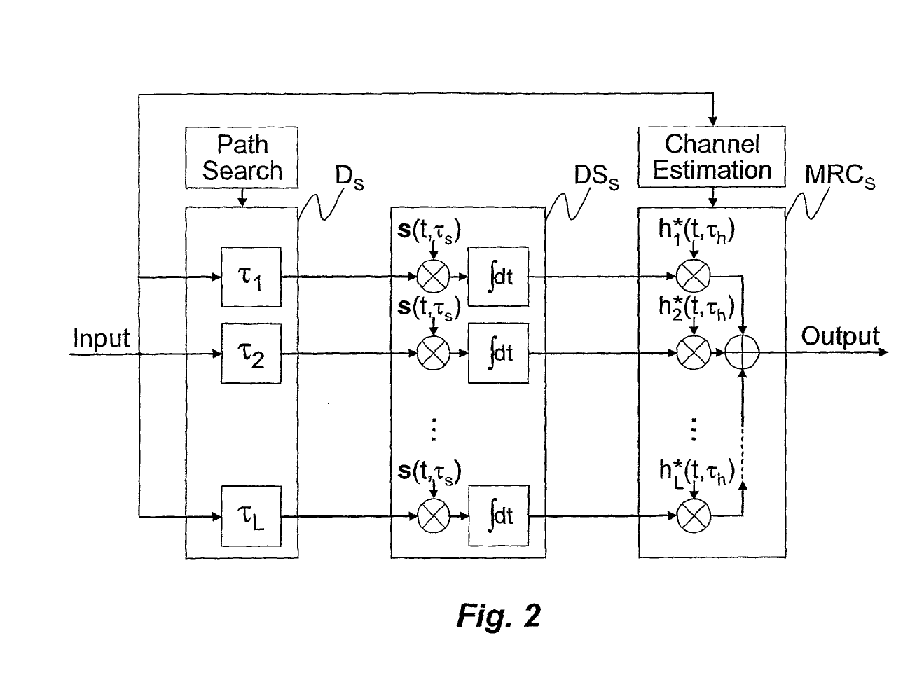

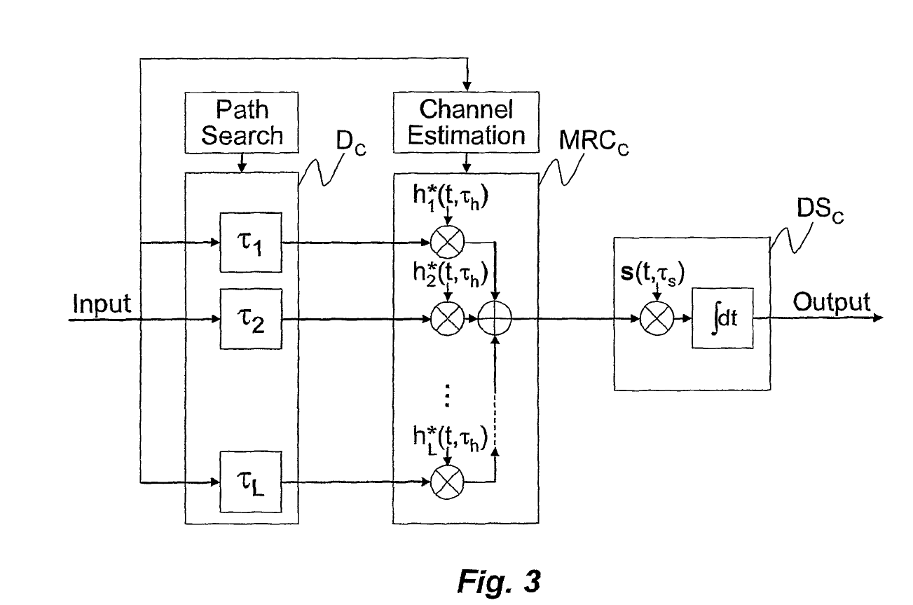

FIG. 8 illustrates schematically two apparatus <<Tx>>, <<Rx>> of a simplified radio communications system operating according to the invention. In practice there will generally be a plurality of such apparatus in a radio communications system. Transmitting and receiving apparatus <Tx>, <<Rx>> in the figure are, e.g., user equipment and base station equipment <<UE>>, <<RBS>> in FIG. 1. The transmitting apparatus <<Tx>> wirelessly sends information to the receiving apparatus <<Rx>>. The receiving apparatus <<Rx>> includes a detector for detecting radio transmissions received from the transmitting entity <<Tx>>.

A person skilled in the art readily understands that the receiver and transmitter properties of, e.g., a user equipment are general in nature. The use of concepts such as mobile station, MS, or radio base station, RBS, within this patent application is not intended to limit the invention only to devices associated with these acronyms. It concerns all devices operating correspondingly, or being obvious to adapt thereto by a person skilled in the art, in relation to the invention. As an explicit non-exclusive example, the invention relates to mobile stations without a subscriber identity module, SIM, as well as user equipments including one or more SIMs.

The invention is not intended to be limited only to the embodiments described in detail above. Changes and modifications may be made without departing from the invention. It covers all modifications within the scope of the following claims.

1. A method of signal to interference and noise ratio (SINR) estimation utilizing one or more channel parameters in a radio communications system for radio transmissions between an access point and user equipment, the method comprising:
performing the SINR estimation using one or more channel specific parameters in addition to one or more parameters related to received signal, noise or interference.

2. The method according to claim 1 where the SINR estimation includes channel gain.

3. The method according to claim 2 where the channel gain is estimated in a receiver.

4. The method according to claim 2 where the estimation includes channel orthogonality factor.

5. The method according to claim 2 where the estimation includes weighted channel gain factors.

6. The method according to claim 2 where when applied to a spread spectrum signal, the SINR is estimated prior to despreading of the received signal.

7. The method according to claim 2 where when applied to a RAKE receiver, the SINR is estimated prior to combining of RAKE fingers of the RAKE receiver.

8. The method according to claim 1 where when applied to a RAKE receiver, the SINR estimation is an estimation of SINR in an uplink direction.

9. An apparatus of signal to interference and noise ratio (SINR) estimation utilizing one or more channel parameters in a radio communications system for radio transmissions between an access point and user equipment, the apparatus comprising:
receiving means for receiving one or more channel specific parameters; and
processing means adapted for inclusion of the one or more channel specific parameters in addition to one or more parameters related to received signal, noise or interference in a SINR estimate.

10. The apparatus according to claim 9 where the processing means is adapted for inclusion of channel gain in the estimate.

11. The apparatus according to claim 10 where the processing means is adapted for estimating channel gain.

12. The apparatus according to claim 10 where the processing means is adapted for inclusion of channel orthogonality factor in the SINR estimate.

13. The apparatus according to claim 10 where the processing means is adapted for inclusion of weighted channel gain factors.

14. The apparatus according to claim 10 where when applied to a spread spectrum signal, the SINR is estimated prior to despreading of the received signal.

15. The apparatus according to claim 10 where when applied to a RAKE receiver, the SINR is estimated prior to combining of RAKE fingers of the RAKE receiver.

16. The apparatus according to claim 9 where the apparatus is included in or is a radio base station.

17. A radio communication system comprising:
receiving means for receiving one or more channel specific parameters; and
processing means for estimating a signal to interference and noise ratio (SINR) using the one or more channel specific parameters, one or more parameters related to received signal, noise or interference, and channel gain.

18. A radio communication system comprising signal to interference and noise ratio (SINR) estimation utilizing one or more channel parameters in the radio communications system for radio transmissions between an access point and user equipment, the radio communication system comprising:
a transmitting apparatus providing radio signal transmissions, the radio signal transmissions being destined for a receiving apparatus,
the receiving apparatus comprising:
processing means adapted for inclusion of one or more channel specific parameters in addition to one or more parameters related to received signal, noise or interference in a SINR estimate.

19. The radio communication system according to claim 18 further comprising:
processing means adapted for inclusion of channel gain factors, the channel gain factors being associated a radio communications channel from the transmitting apparatus to the receiving apparatus, in the SINR estimate.

20. The radio communication system according to claim 18 where the receiving apparatus is included in or is a radio base station.
